(19) United States
(12) Patent Application Publication
(10) Pub. No.: US 2004/0018266 A1
(43) Pub. Date: Jan. 29, 2004

(54) Metering device for a plastics moulding machine

(75) Inventor: Peter Reginald Clarke, Petworth (GB)

Correspondence Address: FLEIT, KAIN, GIBBONS, GUTMAN, BONGINI, & BIANCO P.L., ONE BOCA COMMERCE CENTER, 551 NORTHWEST 77TH STREET, SUITE 111, BOCA RATON, FL, 33487, US

(73) Assignee: Coraltech Limited, Petworth (GB)

(21) Appl. No.: 10/616,129

(22) Filed: Jul. 9, 2003

(30) Foreign Application Priority Data
Jan. 25, 2002 (WO) PCT/GB02/00334
Jan. 26, 2001 (GB) 0102026.2

(51) Int. Cl. B29C 45/56

(52) U.S. Cl. 425/256; 425/562

(57) ABSTRACT

A metering device is disclosed for use in a plastics moulding machine having a mould cavity, relatively movable platens and a feeding passage for feeding a plastics melt into the mould cavity. The metering device comprises a heated block interposed between the feeding means and the mould cavity. A cylinder with a moving piston is formed in the block. A first passage in the block connects the cylinder to the feeding means and a second passage connects the cylinder to the mould cavity. Valves in the passages enable the cylinder to be filled by the feeding passage without the plastic melt entering the mould cavity and subsequently enable the desired dose of plastics melt, when ejected from the cylinder by the piston, to flow from the cylinder to the mould cavity without being returned to the feeding passage.

### CROSS REFERENCE TO RELATED APPLICATIONS

This application is based upon and claims priority from International Patent Application No. PCT/GB02/00334, file Jan. 25, 2002, which is hereby incorporated by reference in its entirety. The International Patent Application claims priority from British Patent Application No. 0102026.2, filed Jan. 26, 2001, which is hereby incorporated by reference in its entirety.

### BACKGROUND OF THE INVENTION

1. Field of the Invention

The present invention relates to injection moulding of plastics material.

2. Description of the Prior Art

An injection moulding machine conventionally comprises a mould made in separable parts, which between them define a mould cavity having the desired shape of the finished article. With the mould closed, molten thermoplastic material is injected into the cavity and solidifies within the mould. The mould is then opened to allow the formed article to be ejected and the mould is again closed to allow the cycle to be repeated.

The molten thermoplastic material is formed by means of a screw. The raw thermoplastic material is fed in granular form into the screw from a hopper. The action of the rotation of the screw compress the granules as they are being heated to form the melt. The melt flows into a chamber lying ahead of a piston formed by the head of the screw. When the mould cavity is to be filled, the screw is moved axially so that the melt is injected by the piston under pressure through a feed gate, controlled by a gate valve, into the mould cavity.

No special metering device is required when forming articles in this way by injection moulding because the plastics melt is required to flow until the cavity is full. Once the cavity has been filled, the flow stops automatically on account of the back pressure that builds up in the mould cavity.

There are occasions, however, when it is not possible to rely on back pressure. It is instead necessary to meter a precise dose of the plastics melt to the mould cavity. One example of a process requiring the plastics material to be metered is when it is desired to form a foamed article. This can be achieved by injecting a thermoplastic material that contains a gas or another foaming agent so that the plastics material expands in the mould, to form an open or closed cell foam. In such a case, the volume of plastics material that is injected is much smaller than the total volume of the mould cavity and unless the plastics melt is accurately metered into the cavity, the density of the foam in the finished article will vary widely.

Another example of a process where back pressure cannot be relied upon to determine the quantity of the plastics melt injected into the mould cavity is described in a co-pending PCT application PCT/GB02/00306 (based on GB 0102026.2 filed on Jan. 26, 2001). In the latter application, a quantity of plastics material is injected into a mould while it is held closed only by a light force that cannot withstand the injection pressure. The injected plastics material once again does not meet with significant resistance during injection. After the required quantity of plastics material has been injected into the mould, the mould cavity is rapidly and forcefully reduced to its minimum volume to force the plastics material to fill the mould cavity completely, using an action similar to forging. In this process, metering the plastics material accurately is again important if one is to avoid production of defective articles.

Accordingly, a need exists to overcome some of the problems and shortcomings of the prior art and to provide a device that may be used in an injection moulding machine to meter accurate doses of a molten thermoplastic material into the mould cavity.

### SUMMARY OF THE INVENTION

According to the present invention, there is provided a metering device for use in a plastics moulding machine having mould cavities that are opened and closed by means of relatively movable platens and a means for feeding a plastics melt into the cavities, the device comprising a heated block to be interposed between the feeding means and the mould cavity, a cylinder formed in the block for each of the cavities, a piston reciprocably mounted in each cylinder, an adjustable stop associated with each piston for enabling the quantity of the plastics melt injected into each cavity to be set independently of the other cavities, first passages formed in the block to connect the cylinders to the feeding means, second passages formed in the block to connect each cylinder to the associated mould cavity, and valves in said passages for enabling the cylinders first to be filled with the desired dose of the plastics melt by the feeding means without the melt entering the mould cavities and for subsequently enabling the desired doses of plastics melt when ejected from the cylinders by the pistons to flow from the cylinders to the respective mould cavities without being returned to the feeding means.

Preferably, each piston is advanced into its cylinder by means of a respective hydraulic, pneumatic or electromechanical actuator.

Conveniently, the valves are constituted by a spool valve having a first position that allows communication only between the cylinder and the feeding means and a second position that allows communication only between the cylinder and the mould cavity.

The piston is preferably designed to reciprocate linearly but it is alternatively possible to use a vane that can rotate within an arcuate slot.

In a mould with multiple cavities, it is well known to provide a hot runner system or manifold to allow all the cavities to be filled from a common feed screw. However, a conventional runner system cannot be used with cavities that are not filled to their maximum capacity because it relies on the back pressure from full cavities to divert the flow to cavities that have yet to be filled.

The present invention mitigates the above problems by providing a separate cylinder for each cavity, all the cylinders being connected to a common inlet connected to the feed screw. When the cylinders are filled, the flow of plastics material to any given cylinder will stop when that cylinder is full and thereafter the flow will be diverted to the other cylinders until all the cylinders are filled to their maximum capacity. Thereafter, each cylinder will transfer its contents only to its own associated mould cavity thereby ensuring that all the mould cavities receive quantities of plastics material that are separately and accurately metered.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention will be apparent from the following detailed description taken in conjunction with the accompanying drawings.

FIG. 1 is a schematic section through part of an injection moulding machine fitted with a metering device, and

FIGS. 2 and 3 are schematic representations of the gate valve used in the embodiment of FIG. 1, each figure showing the valve spool in a different end position.

FIG. 4 is an alternate embodiment of FIG. 3 illustrating other ways to actuate cylinders.

### DESCRIPTION OF THE PREFERRED EMBODIMENTS

It should be understood that these embodiments are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in the plural and vice versa with no loss of generality.

In the drawing like numerals refer to like parts through several views.

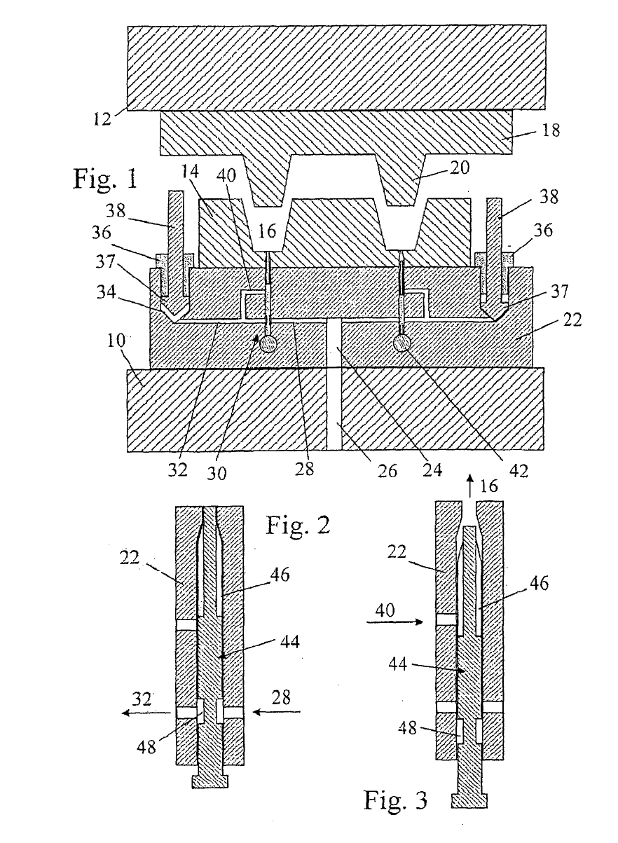

In FIG. 1, there is shown an open mould arranged between the bulkhead 10 and the platen 12 of an injection moulding machine. The bulkhead is stationary 10 and is connected to a conventional screw (not shown) which melts and compresses thermoplastic material fed into it by a hopper and injects the molten plastics material into the mould through the passage 26 in the bulkhead 10.

The platen 12 is moved towards and away from the bulkhead 10, to open and close the mould, by a hydraulic ram that acts on the platen through a system of toggle levers. As the moulding machine is generally conventional and the invention is not restricted to any form of moulding machine, the machine will not itself be described in greater detail.

The illustrated mould is shown in its open position and is shown for simplicity to comprise only two parts, namely a stationary part 14 formed with depressions 16 and a moving part 18 formed with projecting cores 20 that fit into the depressions 16. When the mould is closed, a gap between the depressions 16 and the cores 20 constitutes the mould cavity which has the desired shape of the finished article, in this case a cup. The invention is equally applicable to more complex moulds have more that two relatively movable parts.

Everything described up to this point is conventional. In normal operation, the mould is closed, the cavities are filled to their maximum capacity and the plastics material is allowed to set. Thereafter, the mould is opened, the formed articles are rejected and new moulding cycle is started.

The problem that is addressed by the present invention occurs when the mould cavities do not need to be filled to the point where no more plastics material can be injected by the screw into the cavity. This situation arises, for example, when the article is to be formed of a foamed plastics material, which increases in volume after it has been injected into the mould cavities. Another example where this arises is when the plastics material is injected into the mould while it is partly or fully opened, to be subsequently compressed by the closure of the mould. In such cases it is necessary to meter a precise dose of the plastics material into the mould cavity during each injection without relying on the pressure build up within the mould cavity to limit the quantity of the meld that is injected.

The metering device in FIG. 1 comprises a block 22 that is arranged between the bulkhead 10 and the stationary part 14 of the mould. The block 22 is heated by means of heating elements that pass through it, in order the maintain the thermoplastic material in its molten state, and acts as a distribution manifold. In particular, the block 22 has a common passage 24 in communication with the passage 26 in the bulkhead 10 that leads to the screw and different runners 28 that lead from the common passage to the individual mould cavities.

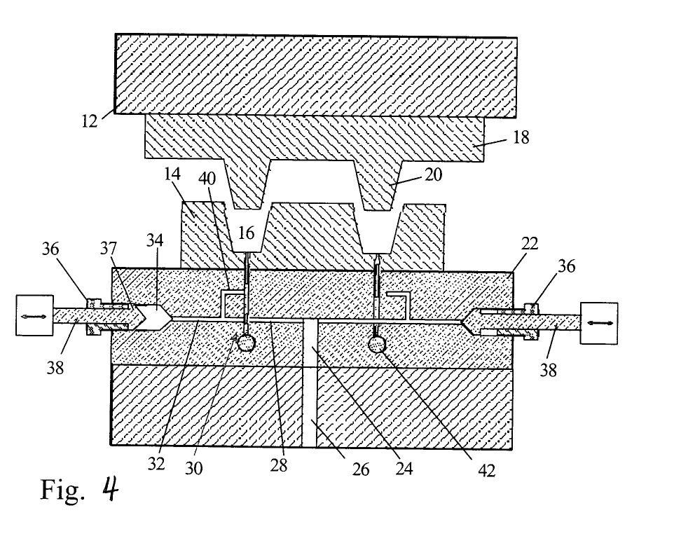

Each cavity has a feed gate comprising a spool valve, which is generally designated 30 and will be described in more detail below by reference to FIGS. 2 and 3. The spool valve acts to control the flow between the runner 28 and a conduit 32 that leads to a cylinder 34. The conduit 32 also has a branch 40 that leads to the feed gate of the cavity, which can also be opened and closed by the spool valve 30. Each spool valve 30 is actuated by a conventional slider 42, which acts on the valve spool to move it axially towards and away from the cavity.

The spool valve is shown in different positions in FIGS. 2 and 3. The spool 44 has an enlarged head at its lower end, as viewed, which is engaged by the actuating slider 42. Along is length, the spool 44 has an annular groove 48 which, when the feed gate is closed as shown in FIG. 2, is aligned with the runner 28 and the conduit 32. In this position of the valve spool 44, the melt can flow around the spool 44 and along the groove to pass from the runner 28 into the conduit 32. In this position of the spool 44, a land of the spool 44 blocks the branch 40 while the tapered end of the spool 44 blocks the feed gate so that no molten plastics material can enter the mould cavity.

When moved by the slider 42 to the position shown in FIG. 3, on the other hand, the spool 44 blocks off the runner 28 and the conduit 32 so that no flow can occur between them. However, the plastics material from the branch 40 can enter into the mould cavity by flowing along axially extending open grooves 46 in the spool 44 that extend to the open feed gate.

The cylinder 34 has its axis parallel to the direction of movement of the platen 12 and contains a piston 37 having a piston rod 38 extending in the same direction towards the moving mould part 18. A stop collar 36 is screwed into the end of the cylinder from which the piston rod projects. The stop collar 36 acts as a guide for the piston rod and also as an adjustable stop by which the stroke of the piston can be limited to adjust the dose metered during each injection cycle.

In operation, while the spool valve 30 closes the feed gate, the feed screw is operate to inject the melt by way of the passage 26 of the bulkhead 10 into the passage 24 of the heated block 22. The melt flows along the runner 28 and through the conduit 32 into the cylinder 34, forcing the piston upwards against its stop collar 36 when the cylinder is full to its maximum capacity. With the piston in this position, the cylinder offers significant back pressure so that the flow of the melt is stopped along the runner 28 and thereby diverted as necessary to any other runner leading to a cylinder that has not yet been filled to its maximum capacity. In this way, the cylinders 34 are all filled with melt during the periods of the operating cycle that the feed gates are closed.

As the mould is being closed, the feed gates are opened by operation of the sliders 42. As earlier described, the spools 44 will now isolate the conduits 32 from their runners 28 and instead connect the branches 40 to the feed gate of the cavity. The closure of the mould brings the mould part 18 into contact with the piston rods 38 and the pistons 37 are thus moved down from the position shown on the left hand side in FIG. 1 to that shown on the right in the same figure. This expels from the cylinder 44 the precisely metered dose of the melt stored in the cylinder 34 and this dose now travels along the conduit 32 and the branch 40 and through the open feed gate into the associated mould cavity. Precise setting of the dose can be effected by suitable adjustment of the position of the stop collar 36.

The illustrated embodiment shows cylinders having pistons that are actuated by the moving mould part 18 but this is not essential to the invention. It would be alternatively possible to use other forms of actuators, such as hydraulic, pneumatic or electromechanical actuators are used. In such a case, it is not necessary for the axes of the cylinders 34 to be parallel to the direction of relative movement of the mould parts 14 and 18. One such embodiment is illustrated in FIG. 4 where the pistons 38 are actuated independent of the moving mould part 18.

Though it is convenient to construct the feed gate so that it acts as a spool valve controlling the flow of the melt into the cylinder, this is not essential. One could instead use a non-return valve which at all times only allows the melt to flow along the runner 28 in the direction from the screw to the cylinder 34.

In the present invention, the mould is a multi-impression mould having many cavities. In the absence of back pressure, it would conventionally be impossible to deliver the correct dose of the melt to each cavity from a common feed screw.

It will be appreciated by the person skilled in the art that various other modifications may be made to the illustrated and described metering device without departing from the scope of the invention as set out in the appended claims. For example, while a linearly reciprocating piston has been shown, it would be alternatively possible to have a variable volume working chamber defined by a vane movable within an arcuate slot.

Although a specific embodiment of the invention has been disclosed, it will be understood by those having skill in the art that changes can be made to this specific embodiment without departing from the spirit and scope of the invention. The scope of the invention is not to be restricted, therefore, to the specific embodiment, and it is intended that the appended claims cover any and all such applications, modifications, and embodiments within the scope of the present invention.

What is claimed is:

1. A metering device for use in a plastics, the device comprising:
a block interposed between at least one feeding passage connected to one or more mould cavities;
at least one cylinder formed in the block for each of the mould cavities;
a single acting piston reciprocably mounted in each cylinder;
an adjustable stop associated with each piston for enabling a predetermined quantity of the plastics melt injected into at least one of the cavities to be set independently of the other cavities;
wherein the block includes formed therein
a first passages to connect the cylinder to the feeding passage;
a second passages to connect the cylinder to each of the mould cavities associated therewith;
one or more valves for enabling the cylinder first to be filled with a desired dose of a plastics melt by the feeding passage without the plastic melt entering the mould cavities and for subsequently enabling the desired doses of plastics melt when ejected from the cylinder by the piston to flow from the cylinder to the respective mould cavities without being returned to the feeding passage.

2. The metering device of claim 1, further comprising:
at least one actuator for advancing the pistons into at least one cylinder.

3. The metering device of claim 2, wherein the actuator is selected from a group of actuators consisting of hydraulic actuators, pneumatic actuators, and electromechanical actuators.

4. The metering device of claim 1, wherein, the valves further comprise spool valves wherein each spool has a first position that allows communication only between the cylinder and the feeding passage associated therewith and a second position that allows communication only between the cylinder and the mould cavity associated therewith.

5. The metering device of claim 3, wherein, the valves further comprise spool valves wherein each spool has a first position that allows communication only between the cylinder and the feeding passage associated therewith and a second position that allows communication only between the cylinder and the mould cavity associated therewith

6. The metering device of claim 1, wherein the valves include non-return valves which only allow the plastic melt to flow in the direction from the feeding passage to the cylinder associated therewith.

7. The metering device of claim 3, wherein the valves include non-return valves which only allow the plastic melt to flow in the direction from the feeding passage to the cylinder associated therewith.

8. The metering device of claim 5, wherein the valves include non-return valves which only allow the plastic melt to flow in the direction from the feeding passage to the cylinder associated therewith.

9. The metering device of claim 1, wherein a surface of the piston is in direct contact with the plastic melt to be fed through the passage.

10. The metering device of claim 8, wherein a surface of the piston is in direct contact with the plastic melt to be fed through the passage.

11. The metering device of claim 3, wherein the actuator is part of a platen, which when moved to a position closer to the mold cavities so as to define a minimum mold cavity volume, the piston is urged by the platen to eject the desired doses of plastic from the cylinder.

12. The metering device of claim 11, wherein an axis of the cylinder is parallel to a direction of relative movement of platen when defining a minimum mold cavity volume.

13. The metering device of claim 3, wherein an axis of the cylinder is substantially normal to a direction of relative movement of platen when defining a minimum mold cavity volume.

14. An injection moulding machine for injection compression moulding, the moulding machine comprising:
a mould part with one or more mold cavities, wherein each of the mold cavities is connected to at least one or more feeding passages;
a pressure plate movable relative to the first mould part between a first end position and a second end position in which the mould is respectively opened and closed;
a block holding the first mould part, the block including at least one cylinder formed in the block with at least one single acting piston reciprocably mounted in the cylinder, the piston including a stop for enabling a quantity of the plastics melt injected into the cavities, wherein the block includes formed therein
a first passages to connect the cylinder to at least one of the feeding passages;
a second passage to connect the cylinder to each of the mould cavities associated therewith;
one or more valves for enabling the cylinder first to be filled with a desired dose of a plastics melt by the feeding passage without the plastic melt entering the mould cavities and for subsequently enabling the desired dose of plastics melt when ejected from the cylinder by the single acting piston to flow from the cylinder to the respective mould cavities without being returned to the feeding passage.

15. The injection moulding machine of claim 14, further comprising:
at least one actuator for advancing the single acting piston into the cylinder.

16. The injection moulding machine of claim 15, wherein the actuator is selected from a group of actuators consisting of hydraulic actuators, pneumatic actuators, and electro-mechanical actuators.

17. The injection moulding machine of claim 14, wherein, the valves further comprise spool valves wherein each spool has a first position that allows communication only between the cylinder and the feeding passage associated therewith and a second position that allows communication only between the cylinder and the mould cavity associated therewith.

18. The injection moulding machine of claim 16, wherein, the valves further comprise spool valves wherein each spool has a first position that allows communication only between the cylinder and the feeding passage associated therewith and a second position that allows communication only between the cylinder and the mould cavity associated therewith.

19. The injection moulding machine of claim 14, wherein the valves include non-return valves which only allow the plastic melt to flow in the direction from the feeding passage to the cylinder associated therewith.

20. The injection moulding machine of claim 16, wherein an axis of the cylinder is parallel to a direction of relative movement of platen when defining a minimum mold cavity volume.

21. The injection moulding machine of claim 16, wherein an axis of the cylinder is substantially normal to a direction of relative movement of platen when defining a minimum mold cavity volume.
